(19) United States
(12) Patent Application Publication
(10) Pub. No.: US 2007/0036926 A1
(43) Pub. Date: Feb. 15, 2007

(54) Multilayered pipes

(76) Inventors: Robert B. Fish JR., Parkersburg, WV (US); Steven A. Mestemacher, Parkersburg, WV (US); Patricia A. Tooley, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/500,017

(22) Filed: Aug. 7, 2006

Related U.S. Application Data
(60) Provisional application No. 60/707,596, filed on Aug. 12, 2005.

(51) Int. Cl. F16L 11/04

(52) U.S. Cl. 428/36.91

(57) ABSTRACT

Multilayered pipes comprising layers of functionalized melt-extrudable fluoropolymer, polyamide, and reinforcing fiber. Optional additional layers include melt-extrudable fluoropolymer and a thermoplastic polymer layer. The pipes are particularly useful in district heating applications.

### CROSS REFERENCE TO RELATED APPLICATIONS

This application claims the benefit of priority to U.S. Provisional Application No. 60160/707,596, filed Aug. 12, 2005.

### FIELD OF THE INVENTION

The present invention relates to multilayered pipes comprising individual layers of functionalized melt-extrudable fluoropolymer, polyamide, and reinforcing fiber. Optional additional layers include melt-extrudable fluoropolymer and a thermoplastic polymer layer. The pipes are particularly useful in district heating applications.

### BACKGROUND OF THE INVENTION

Pipes are used to convey a wide variety of substances under a wide variety of conditions. A particularly demanding application is the conveyance of hot water or steam. Pipes suitable for such applications must be able to withstand elevated pressures and must be corrosion resistant. For example, district heating systems are one such application. These systems are used to provide steam and hot water generated at a central source to multiple buildings, often for heating purposes. District heating is used in many colleges and universities, industrial campuses, manufacturing plants, Russian cities such as Moscow and St. Petersburg, and the like. The central sources used are quite diverse and can include geothermal sources, cogeneration plants, industrial waste heat sources, and steam generation plants built for that purpose. District heating systems typically use pipes to convey superheated water and temperatures of around 100 to 150° C. are often encountered. As a result, such systems typically use metal (such as stainless steel) pipes. It would be desirable to use polymeric pipes in many such applications, as such materials are often more available and are often significantly simpler and less costly to install and maintain.

Polymeric pipes suitable for use in such systems will preferably be chemically resistant, able to withstand the temperatures and pressures of the superheated water and steam they convey, and puncture resistant.

Other examples of demanding applications include the conveyance of alcohols, hydrocarbons, and other organic liquids and pipes suited to these applications are preferably similarly chemically, temperature, pressure, and puncture resistant.

U.S. Pat. No. 6,524,671 discloses a coextruded laminate comprising a layer of fluoropolymer directed adhered to a layer of polyamide in the absence of any tie layer between the layers.

EP 84088 discloses a multilayered pipe that may comprise a thin layer of poly(perfluoroethylene propylene) or poly(vinylidene fluoride), a metal foil layer for permeation resistance, an extrudable polymer layer, a pressure and temperature resistant layer made from fibers, an insulating layer, a diffusion-protection layer, and a protection layer. However, the metal foil in such pipes is susceptible to corrosion, which could lead to failure of the pipe.

### SUMMARY OF THE INVENTION

There is disclosed and claimed herein a multilayered pipe comprising a layer comprising (a) a layer comprising a functionalized melt-extrudable fluoropolymer; (b) a layer comprising a polyamide; and (c) a layer comprising reinforcing fibers, wherein the layers are arranged concentrically such that layer (a) is innermost, layer (b) is outside layer (a), and layer (c) is outside layer (b). The pipe may further optionally comprise one or more of (a′) a layer comprising a melt-extrudable fluoropolymer, and (d) a layer comprising a thermoplastic polymer, where (a′) is innermost and layer (d) is outside layer (c). The pipes may be used in district heating and chemical process applications or as an undersea flex pipe or component of a marine umbilical.

### BRIEF DESCRIPTION OF THE DRAWINGS

FIG. 1 is a cross-sectional diagram of a multilayered pipe of the present invention.

FIG. 2 is a cross-sectional diagram of an embodiment of the multilayered pipe of the present invention.

FIG. 3 is a cross-sectional diagram of an alternative embodiment of the multilayered pipe of the present invention.

FIG. 4 is a cross-sectional diagram of a further alternative embodiment of the multilayered pipe of the present invention.

### DETAILED DESCRIPTION OF THE INVENTION

As used herein, the term “multilayered pipes” refers to structures defining a cavity therethrough for conducting a fluid, including, without limitation, any liquid, gas, or finely divided solid. The walls of the structures comprise three or more concentric layers. They may have a circular or roughly circular (e.g. oval) cross-section. However more generally the pipes may be shaped into seemingly limitless geometries so long as they define a passageway therethrough. For example suitable shapes may include polygonal shapes or curvilinear shapes and may even incorporate more that one shape along the length thereof. The pipes may further be joined together by suitable means to form T-sections, branches, and the like. The multilayered pipes and any or all of their concentric layers may be flexible or stiff and have a variety of wall thicknesses and (in the event that the pipes are circular in cross section) diameters.

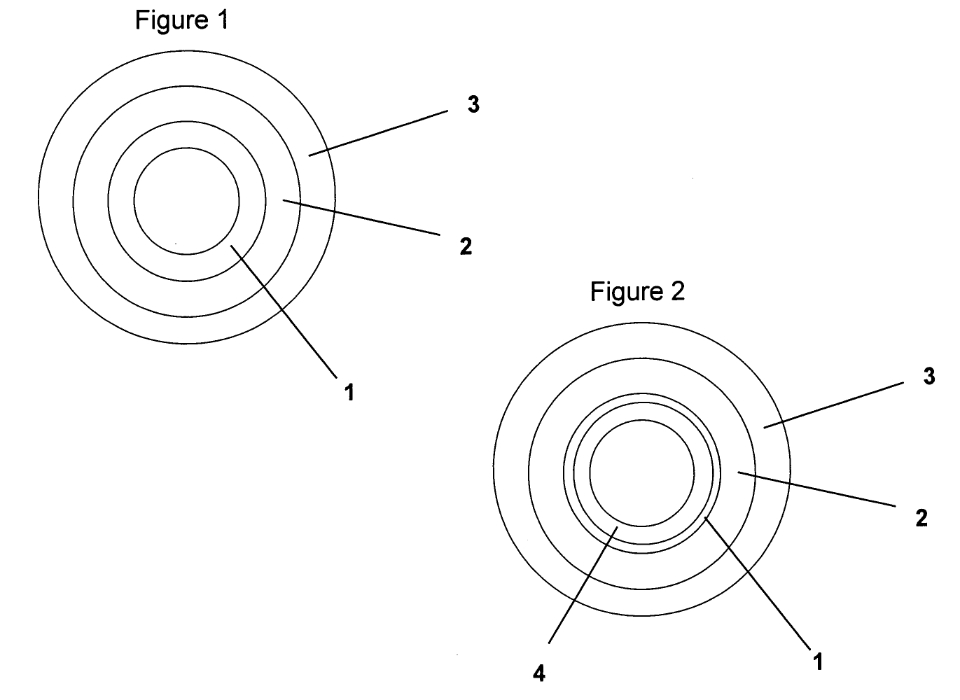

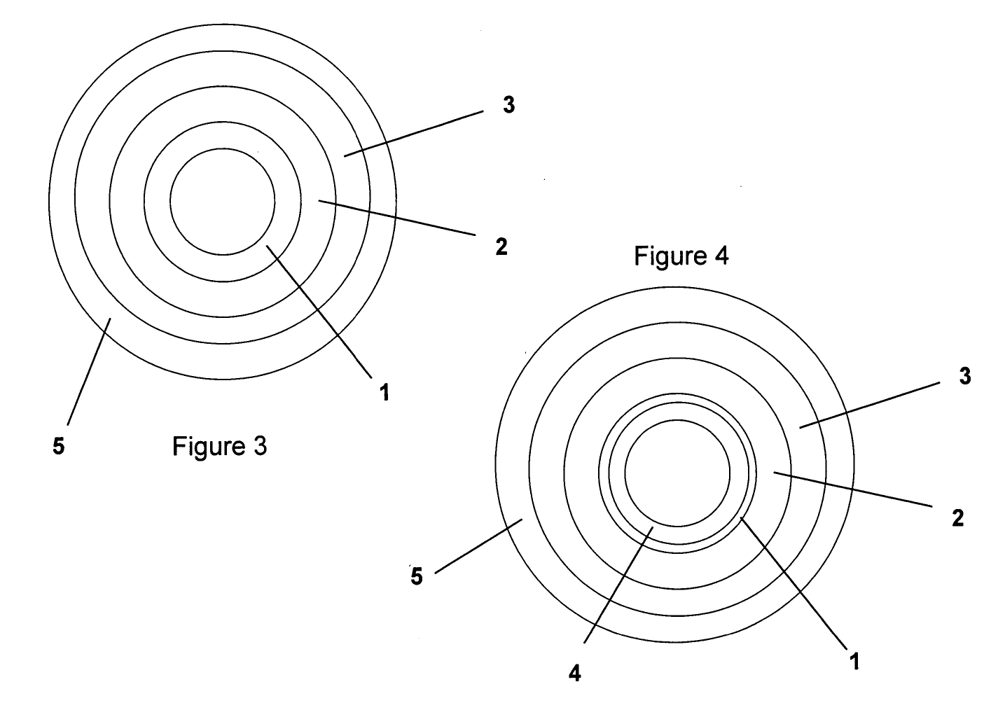

As illustrated in FIG. 1, the multilayered pipes of the present invention comprise at least three concentric layers, as follows: a first layer (a) of functionalized melt-extrudable fluoropolymer (1), a second layer (b) of polyamide (2), and a third layer (c) of reinforcing fiber (3). Layer (a) (1) is innermost. Layer (b) (2) is outside layer (a) (1). Layer (c) (3) is outside layer (b) (2). As shown in FIG. 2, the multilayered pipes may further comprise a layer (a′) 4 of melt-extrudable fluoropolymer, where layer (a′) (4) is situated such that layer (a) (1) lies between layer (a′) (4) and layer (b) (2). As shown in FIG. 3, the multilayered pipes may have a configuration similar to that of FIG. 1 and additionally may further comprise a layer (d) (5) of thermoplastic polymer that is situated outside layer (c) (3). In a preferred embodiment as shown in FIG. 4, the multilayered pipe comprises layers (a′) (4), (a) (1), (b) (2), (c) (3), and (d) (5).

Layer (a) (1) may adhere polyamide layer (b) (2) to fluoropolymer layer (a′) (4) when the latter layer is present. Layers (a) (1) and (a′) (4) (when present) may serve to provide permeation resistance to water and may be resistant to elevated temperatures. Layer (c) (3) may serve to provide burst resistance to the pipe. Each layer of the pipe is in contact with the layer (if any) positioned inside it and the layer (if any) positioned outside it. The pipe may optionally comprise additional layers inside layer (a′), outside layer (d), or interspersed between layers (a′), (a), (b), (c), and/or (d). Such additional layers may be formed from any of a variety of materials to meet specific needs.

The pipes may be used to transport a variety of fluids, such as water (including steam and super-heated steam) and hydrocarbons, alcohols, and other organic liquids and mixtures of any of the foregoing.

The materials for layers (a), (b), and (d) are preferably selected such that each layer has a permeability to the fluid that the pipe is intended to transport (referred to as “fluid permeability”) that is greater than or equal to that of the layer that is directly inside it. In other words, the fluid permeability of layer (a) is greater than or equal to that of layer (a′) when present; the fluid permeability of layer (b) is greater than or equal to that of layer (a); and the fluid permeability of layer (d), when present, is greater than or equal to that of layer (b). Furthermore, if the pipe contains optional layers inside layer (a′), outside layer (d), or interspersed between layers (a′), (a), (b), (c), and/or (d), the materials used for the layers are selected such that each layer has a fluid permeability that is greater than or equal to that of the layer that is directly inside it. This prevents components of the fluid from building up between or within layers, which may lead to delamination of the layers or to hydrolysis of the material comprising the layers. It is not necessary that, if present, the layer outside layer (c) (reinforcing fiber) have a fluid permeability that is greater than that of layer (c)

The permeability of the materials by fluid molecules may be measured by mounting a film or thin extruded piece of the material having a known thickness on Thwing-Albert Vapometer cups (available from Thwing Albert Instrument Company, West Berlin, N.J.) filled about ¾ full with the fluid to be transported and placed in an oven at temperatures representative of the operating range for the application for the pipe. The cups are weighed daily and the average daily weight loss is recorded.

The fluid permeation coefficient (R) is calculated by dividing the rate of daily fluid loss by the area of the material exposed to the contents of the cup and multiplying the result by the thickness of the film.

The permeability of a given layer is determined by multiplying the fluid permeation coefficient by the thickness (T) of the layer. Thus for two layers 1 and 2, where layer 2 is outside layer 1:

$$\frac{{R}_{1} / {T}_{1}}{{R}_{2} / {T}_{2}} \leq 1$$

where R₁ and R₂ are the fluid permeation coefficients of layers 1 and 2, respectively, and T₁ and T₂ are the thicknesses of layers 1 and 2, respectively. It will be appreciated by those skilled in the art that a layer that is outside another layer will have a greater surface area available for fluid permeation. The thickness of the layers selected for the pipes of the present invention will preferably be selected to ensure that in the course of operation, fluid is able to permeate each layer (with the exception of layers comprising fibrous reinforcing materials) at a rate greater than or equal to that of the layer below it.
Fluoropolymer Layers (a) and (a′)

The fluoropolymers of layers (a) and (a′) are melt-extrudable. By “melt-extrudable” fluoropolymer is meant a fluoropolymer having a melt viscosity in the range of about 0.5×10³ to about 60×10³ Pa·s as normally measured for the particular fluoropolymer by one skilled in the art. For example, ASTM method D1238 describes methods for measuring melt flow rates for fluoropolymers. ASTM method D3159 describes a method of measuring melt flow rates for tetrafluoroethylene-ethylene polymers. ASTM method D3222 describes a method of measuring melt flow for vinylidene fluoride polymers. ASTM method D5575 described a method of measuring melt flow for copolymers of vinylidene fluoride with other fluorinated monomers. As will be understood by one skilled in the art, these methods are also suitable for polymers further comprising repeat units derived from other monomers. As will be appreciated by one skilled in the art, melt flow rates may converted directly to melt viscosities.

The fluoropolymers are derived from at least one fluorine-containing monomer, but may be derived in part from at least one monomer that contains no fluorine or other halogen. The fluoropolymer is preferably derived from at least one monomer that contains hydrogen. The hydrogen to fluorine ratio in the fluoropolymer is preferably at least about 0.1:1. The fluoropolymers preferably contain at least about 35 weight percent fluorine. Examples of melt-extrudable fluoropolymers are given in U.S. Pat. No. 6,284,335, which is hereby incorporated by reference herein.

Melt-extrudable fluoropolymer (a′) is different from melt-extrudable fluoropolymer (a). Fluorine-containing monomers that may be used to make the melt-extrudable fluoropolymer (a′) include fluoroolefins containing 2 to 8 carbon atoms and fluorinated vinyl ethers of the formula CY₂═CYOR or CY₂═CYOR′OR, wherein each Y is independently H or F and R and R′ are independently completely fluorinated or partially fluorinated linear or branched alkyl and alkylene groups containing 1 to 8 carbon atoms. Preferred R groups contain 1 to 4 carbon atoms and are preferably perfluorinated. Preferred R′ groups contain 2 to 4 carbon atoms and are preferably perfluorinated.

Examples of suitable fluorine-containing monomers include tetrafluoroethylene (TFE), chlorotrifluoroethylene (CTFE), perfluoro(propyl vinyl ether) (PPVE), perfluoro(ethyl vinyl ether) (PEVE), perfluorobutyl ethylene (PFBE), hexafluoroisobutylene (HFIB), vinylidene fluoride, vinyl fluoride, and hexafluoropropylene (HFP).

Hydrocarbon monomers that can be used to make the melt-extrudable fluoropolymer include ethylene, propylene, n-butylene, and iso-butylene.

Preferred fluoropolymers include copolymers of ethylene with perhalogenated monomers such as tetrafluoroethylene (TFE) or chlorotrifluoroethylene (CTFE), such copolymers being often referred to as ETFE and ECTFE, respectively. ETFE may optionally contain repeat units derived from minor amounts of one or more additional comonomers. The use of additional comonomers may decrease the high temperature brittleness of such polymers. Perfluoro(propyl vinyl ether) (PPVE), perfluoro(ethyl vinyl ether) (PEVE), perfluorobutyl ethylene (PFBE), and hexafluoroisobutylene (HFIB) are preferred additional comonomers. ECTFE may also be derived from additional comonomers. A preferred ETFE is Tefzel® 2181, supplied by E.I. DuPont de Nemours & Co., Wilmington, Del.

Other preferred fluoropolymers include vinylidene fluoride polymers, including copolymers with other perfluoroolefins, particularly hexafluoropropylene (HFP), and optionally, TFE. Other preferred fluoropolymers are TFE/HFP copolymers derived from small amounts of vinylidene fluoride. Such polymers preferably contain about 50 to about 80 mole percent of repeat units derived from TFE, about 10 to about 45 mole percent of repeat units derived from vinylidene fluoride, and about 5 to about 20 mole percent of repeat units derived from HFP. Other preferred fluoropolymers include copolymers of TFE with HFP and/or PPVE or perfluoro(ethyl vinyl ether).

The melt-extrudable fluoropolymers are usually partially crystalline as indicated by a non-zero heat of fusion associated with a melting endotherm as measured by DSC (differential scanning calorimetry) on first melting, and are considered to be fluoroplastics rather than fluoroelastomers.

Layer (a) of the pipes comprises a functionalized melt-extrudable fluoropolymer. By “functionalized melt-extrudable fluoropolymer” is meant a melt-extrudable fluoropolymer containing functional groups capable of reacting with amine or carboxylic acid groups present in a polyamide. Examples of such functional groups include carboxylic groups such as one or more of dicarboxylic acids and diesters, dicarboxylic monoesters, acid anhydrides, carboxylic acids and esters, and salts of carboxylic acids and dicarboxylic acids. Carboxylic acid salts are neutralized carboxylic acids. Other useful functional groups include epoxy groups, hydroxyl groups, and sulphonic and phosphonic acids and their esters and salts.

The functional groups may be incorporated into the fluoropolymer by grafting unsaturated molecules containing the functional groups (referred to as “functionalized grafting compounds”) to a melt extrudable fluoropolymer. The melt-extrudable fluoropolymers described above for use in fluoropolymer layer (a′) may be grafted to prepare the functionalized melt-extrudable fluoropolymer. The unsaturated molecules are preferably ethylenically unsaturated. Suitable methods for grafting are described in U.S. Pat. No. 5,576,106 and WO 96/03448, which are hereby incorporated herein by reference. Preferred unsaturated molecules (functionalized grafting compounds) include glycidyl methacrylate and maleic anhydride, maleic acid, fumaric acid, itaconic acid, and esters thereof.

The amount of grafting compound grafted to the fluoropolymer is preferably generally about 0.01 to about 5 weight percent, or more preferably about 0.01 to about 3 weight percent, or yet more preferably about 0.05 to about 1 weight percent, based on the total amount of functionalized fluoropolymer.

The functional groups can also be introduced into the fluoropolymer when it is made by copolymerizing monomers containing suitable functional groups (functionalized monomers) with the monomers described above for use in preparing the melt-extrudable fluoropolymer of layer (a′). Examples of suitable functionalized comonomers include hydroxyfluorovinylethers such as CF₂═CF[OCF₂CF(CF₃)]ₘ(O)ₚ(CF₂)ₙCH₂OH, as disclosed in U.S. Pat. No. 4,982,009, which is hereby incorporated by reference herein, and their alcoholic esters CF₂═CF[OCF₂CF(CF₃)]ₘO(CF₂)ₙ(CH₂)ₚOCOR, as disclosed in U.S. Pat. No. 5,310,838, which is hereby incorporated by reference herein. Additional suitable fluorovinylether functionalized comonomers include CF₂═CF[OCF₂CF(CF₃)]ₘO(CF₂)ₙCOOH and their carboxylic esters CF₂═CF[OCF₂CF(CF₃)]ₘO(CF₂)ₙCOOR disclosed in U.S. Pat. No. 4,138,426, which is hereby incorporated by reference herein. In these formulae, m=0-3, n=1-4, p=1-2, and R is methyl or ethyl. Additional suitable functionalized comonomers are disclosed in EP 0 626 424, which is hereby incorporated by reference herein. Other functionalized comonomers include those such as CF₂═CFCF₂—Z—(CH₂)_{w}—X wherein X is CH₂OH, COOR, or epoxy; R is H or an alkyl group having 1 to 6 carbon atoms; Z is R_{f}¹ or O—R_{f}², where R_{f}¹ is a fluorine-substituted alkylene group having 1 to 40 carbon atoms and R_{f}² is a fluorine-substituted alkylene group having 1 to 40 carbon atoms or a fluorine substituted ether group having 3 to 50 carbon atoms; and w is 0 or an integer between 1 and 6, inclusive, as disclosed in EP 0 728 776, which is hereby incorporated by reference herein.

The functionalized melt-extrudable fluoropolymer made by copolymerizing monomers containing suitable functional groups will preferably contain no more than about 10 weight percent, or more preferably about 0.01 to about 10 weight percent, or yet more preferably about 1 to about 5 weight percent of repeat units derived from functionalized comonomers, based on the total weight of the functionalized fluoropolymer.

The fluoropolymers used in the present invention may optionally further comprise additives such as cross-linking agents/initiators, extenders and fillers such as micas, silanes, titanates, zirconates, and liquid crystalline polymers having thermal stability similar to that of polyamide, thermal stabilizers, bactericides/fungicides/mildewicides, processing aids, conductive and static dissipative agents, colorants, antioxidants, and the like.

Addition of such additives to fluoropolymer can be accomplished by any of the conventional means for incorporating additives into fluoroplastics, such as through the use of a compounding mill, a Banbury mixer, or a mixing extruder. It is also possible to blend the additive(s) and fluoropolymer in the solid state, and thereafter to cause uniform distribution of additive by passing the blend through a melt extruder, as would normally be done during fabrication of a shaped article.

A preferred functionalized melt-extrudable fluoropolymer is ETFE grafted with maleic anhydride. Such a material is Tefzel® 2202, available from E.I. DuPont de Nemours & Co., Wilmington, Del.

Polyamide layer (b)

The polyamide used in layer (b) may be a single polyamide or comprise a blend of two or more polyamides. The polyamides preferably have sufficiently high melt-strength, melt viscosity, and melt elasticity to allow then to be extruded into pipes.

Suitable polyamides can be condensation products of dicarboxylic acids or their derivatives and diamines, and/or aminocarboxylic acids, and/or ring-opening polymerization products of lactams. Suitable dicarboxylic acids include, adipic acid, azelaic acid, sebacic acid, dodecanedioic acid, isophthalic acid and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable lactams include caprolactam and laurolactam.

Suitable polyamides include aliphatic polyamides such as polyamide 6; polyamide 6,6; polyamide 4,6; polyamide 6,9; polyamide 6,10; polyamide 6,12; polyamide 10,10; polyamide 11; polyamide 12; semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene isophthalamide and hexamethylene adipamide (polyamide 6,1/6,6); the polyamide of hexamethylene terephthalamide, hexamethylene isophthalamide, and hexamethylene adipamide (polyamide 6,T/6,1/6,6) and copolymers and mixtures of these polymers.

Examples of suitable aliphatic polyamides include polyamide 6,6/6 copolymer; polyamide 6,6/6,8 copolymer; polyamide 6,6/6,10 copolymer; polyamide 6,6/6,12 copolymer; polyamide 6,6/10 copolymer; polyamide 6,6/12 copolymer; polyamide 6/6,8 copolymer; polyamide 6/6,10 copolymer; polyamide 6/6,12 copolymer; polyamide 6/10 copolymer; polyamide 6/12 copolymer; polyamide 6/6,6/6,10 terpolymer; polyamide 6/6,6/6,9 terpolymer; polyamide 6/6,6/11 terpolymer; polyamide 6/6,6/12 terpolymer; polyamide 6/6,10/11 terpolymer; polyamide 6/6,10/12 terpolymer; and polyamide 6/6,6/PACM (bis-p-{aminocyclohexyl}methane) terpolymer.

Preferred polyamides include polyamide 6,6; polyamide 6,12; polyamide 6,10; polyamide 11; polyamide 12; copolyamides of hexamethylenediamine, dodecanedioic acid, and decanoic acid (polyamide 6,12/6,10); copolyamides of hexamethylenediamine, dodecanedioic acid, and terephthalic acid (polyamide 6,12/6,T); copolyamides of hexamethylenediamine, decanedioic acid, and terephthalic acid (polyamide 6,10/6,T); copolyamides of hexamethylenediamine, adipic acid, and terephthalic acid (polyamide 6,6/6,T); and copolymers thereof.

The polyamide of layer (b) may be in the form of a polyamide composition. The polyamide composition may comprise additives such as plasticizers, heat stabilizers, lubricants and mold-release aids, nanofillers (such as nanoclays), antioxidants, UV stabilizers, colorants, impact modifiers, conductive and static dissipative agents, coupling and cross-linking agents, fillers, and the like. A preferred polyamide composition comprises one or more plasticizers. Examples of suitable plasticizers include among others sulfonamides, preferably aromatic sulfonamides such as benzenesulfonamides and toluenesulfonamides. Examples of suitable sulfonamides include N-alkyl benzenesulfonamides and toluenesufonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide. N-Butylbenzenesulfonamide is preferred. When the polyamide is polyamide 6,12/6,10, the plasticizer is preferably present in about 6 to about 14 weight percent, based on the total weight of the polyamide and the plasticizer.

The polyamide composition is made by melt-blending the components using any method known in the art, such as an extruder or kneader. The composition may be prepared in a separate step before it is used to prepare the pipes of the present invention, or the composition may be prepared by melt-blending two or more components in any suitable apparatus, such as an extruder, to form a melt that may be used directly to form the pipes of the present invention without an intervening solidification step.

Reinforcing Layer (c)

The reinforcing fiber of layer (c) comprises one or more fibers, such as para-aramid fibers, carbon fibers, polyester fibers, glass fibers, or metal fibers. The fibers preferably have an initial modulus of at least about 200 grams/denier or more preferably at least about 300 grams/denier. The initial modulus is defined in ASTM D2101-1985.

As used herein, “aramid” is meant a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material can be blended with the aramid or that copolymers can be used having as much as about 10 percent of other diamine substituted for the diamine of the aramid or as much as about 10 percent of other diacid chloride substituted for the diacid chloride of the aramid.

Methods for making para-aramid fibers useful in this invention are generally disclosed in, for example, U.S. Pat. Nos. 3,869,430; 3,869,429; and 3,767,756. Such aromatic polyamide organic fibers and various forms of these fibers are available from E.I. DuPont de Nemours & Co., Wilmington, Del. under the trademark Kevlar® fibers.

Preferred para-aramid fibers include poly(paraphenylene terephthalamide) fibers.

A preferred Kevlar® fiber includes Kevlar® 29 fiber.

Thermoplastic Polymer Layer (d)

The thermoplastic polymer of layer (d) may be any thermoplastic polymer or polymer composition. Preferred thermoplastics include polyamides, including those preferred for use in layer (b) as set forth earlier herein.

The multilayered pipes may be assembled by any method known to those skilled in the art. For example, the materials of the innermost layers (a), (b), and, optionally (a′), may be coextruded to form a three-layer structure that may then be wrapped with the fibers of layer (c), and finally the polymer of layer (d) may be added using, for example, an extruder. Alternatively, layers (a) and (a′) may be coextruded to form a three-layered structure over which the polyamide of layer (b) may be extruded to form a three-layered structure that may then be wrapped with the fibers of layer (c), and finally the polymer of layer (d) may be added using, for example, an extruder.

Parts of the extruders used to handle molten fluoropolymers of layers (a) and (a′) may need to be constructed from special metal alloys to minimize corrosion during processing. Preferred materials are high nickel alloys, such those sold under the trademark Hastelloy® by Haynes International, Kokomo, Ind. The fibers of layer (c) may be wrapped using conventional equipment and their pitch and coverage will be selected based on the size of the pipe and the pressure requirements of the application.

The pipes of the present invention preferably comprise no layers made from metal films, foils, sheets, and the like. All layers of the pipes are preferably made from polymeric materials, except when the reinforcing fiber of layer (c) comprises a non-polymeric fibrous material.

The multilayered pipes of the present invention may be used in a district heating system or as components of undersea flex pipes or marine umbilicals. They may be used to transport chemicals in chemical processes in industrial settings (referred to as chemical process pipes). The pipes of the present invention may be used as injection well pipes (for oil and/or gas wells). The pipes of the present invention may be used for the transportation of gasoline and/or diesel fuel or gasoline station forecourt pipes.

What is claimed is:

1. A multilayered pipe comprising:
(a) a layer comprising a functionalized melt-extrudable fluoropolymer layer,
(b) a layer comprising a polyamide, and
(c) a layer comprising reinforcing fibers,
wherein the layers are arranged concentrically such that layer (a) is innermost, layer (b) is outside layer (a), and layer (c) is outside layer (b).

2. The multilayered pipe of claim 1, comprising:
(a′) a layer comprising a melt-extrudable fluoropolymer,
(a) a layer comprising a functionalized melt-extrudable fluoropolymer layer,
(b) a layer comprising a polyamide, and
(c) a layer comprising reinforcing fibers,
wherein the layers are arranged concentrically such that layer (a′) is innermost, layer (a) is outside layer (a′), layer (b) is outside layer (a), and layer (c) is outside layer (b).

3. The multilayered pipe of claim 1, comprising:
(a) a layer comprising a functionalized melt-extrudable fluoropolymer layer,
(b) a layer comprising a polyamide,
(c) a layer comprising reinforcing fibers,
(d) a layer comprising a thermoplastic polymer,
wherein the layers are arranged concentrically such that layer (a′) is innermost, layer (a) is outside layer (a′), layer (b) is outside layer (a), layer (c) is outside layer (b), and layer (d) is outside layer (c).

4. The multilayered pipe of claim 1, comprising:
(a′) a layer comprising a melt-extrudable fluoropolymer,
(a) a layer comprising a functionalized melt-extrudable fluoropolymer layer,
(b) a layer comprising a polyamide,
(c) a layer comprising reinforcing fibers,
(d) a layer comprising a thermoplastic polymer,
wherein the layers are arranged concentrically such that layer (a′) is innermost, layer (a) is outside layer (a′), layer (b) is outside layer (a), layer (c) is outside layer (b), and layer (d) is outside layer (c).

5. The pipe of claim 1, wherein the polyamide of layer (b) is selected from the group consisting of polyamide 6,10; polyamide 6,12; polyamide 11; and polyamide 12.

6. The pipe of claim 1, wherein the polyamide is a polyamide composition comprising plasticizer.

7. The pipe of claim 6, wherein the plasticizer is one or more of N-butylbenzenesulfonamide, N-ethyl-o-toluenesulfonamide, or N-ethyl-p-toluenesulfonamide.

8. The pipe of claim 1, wherein the fluoropolymer of layer (a) is one or more of ethylene/tetrafluoroethylene copolymers grafted with a functionalized grafting compound, ethylene/chlorotrifluoroethylene copolymers grafted with a functionalized grafting compound, vinylidene fluoride/hexafluoropropylene copolymers grafted with a functionalized grafting compound, and vinylidene fluoride/hexafluoropropylene/tetrafluoroethylene copolymers grafted with a functionalized grafting compound.

9. The pipe of claim 8, wherein the fluoropolymer of layer (a) is one or more of ethylene/tetrafluoroethylene copolymers grafted with maleic anhydride, ethylene/chlorotrifluoroethylene copolymers grafted with maleic anhydride, vinylidene fluoride/hexafluoropropylene copolymers grafted with maleic anhydride, and vinylidene fluoride/hexafluoropropylene/tetrafluoroethylene copolymers grafted with maleic anhydride.

10. The pipe of claim 2, wherein the fluoropolymer of layer (a′) is one or more of ethylene/tetrafluoroethylene copolymers, ethylene/chlorotrifluoroethylene copolymers, vinylidene fluoride/hexafluoropropylene copolymers, and vinylidene fluoride/hexafluoropropylene/tetrafluoroethylene copolymers.

11. The pipe of claim 3, wherein the thermoplastic polymer of layer (d) is a polyamide.

12. The pipe of claim 11, wherein the thermoplastic polymer of layer (d) is a polyamide is selected from the group consisting of polyamide 6,10; polyamide 6,12; polyamide 11; and polyamide 12.

13. The multilayered pipe of claim 1, wherein the reinforcing fibers of layer (c) are one or more selected from the group consisting of para-aramid fibers, carbon fibers, polyester fibers, and glass fibers.

14. The multilayered pipe of claim 13, wherein the reinforcing fibers of layer (c) are para-aramid fibers.

15. The multilayered pipe of claim 13, wherein the reinforcing fibers of layer (c) are glass fibers.

16. The pipe of claim 1, wherein layer (b) has a fluid permeability that is greater than or equal to that of layer (a).

17. The pipe of claim 2, wherein layer (a) has a fluid permeability that is greater than or equal to that of layer (a′) and layer (b) has a fluid permeability that is greater than or equal to that of layer (a).

18. The pipe of claim 3, wherein layer (b) has a fluid permeability that is greater than or equal to that of layer (a) and layer (d) has a fluid permeability that is greater than or equal to that of layer (b).

19. The pipe of claim 4, wherein layer (a) has a fluid permeability that is greater than or equal to that of layer (a′), layer (b) has a fluid permeability that is greater than or equal to that of layer (a), and layer (d) has a fluid permeability that is greater than or equal to that of layer (b).

20. The pipe of claim 1 in the form of a district heating pipe, chemical process pipe, injection well pipe, or gasoline station forecourt pipe.

21. The pipe of claim 1 in the form of an undersea flex pipe or marine umbilical component.
